(19) United States
(12) Patent Application Publication
(10) Pub. No.: US 2015/0323749 A1
(43) Pub. Date: Nov. 12, 2015

(54) SURFACE MOUNT DEVICE (SMD) OPTICAL PORT

(71) Applicant: Avago Technologies General IP (Singapore) Pte. Ltd., Singapore (SG)

(72) Inventor: Peter Roider, Regensburg (DE)

(73) Assignee: Avago Technologies General IP (Singapore) Pte. Ltd., Singapore (SG)

(21) Appl. No.: 14/274,732

(22) Filed: May 11, 2014

(51) Int. Cl. G02B 6/42

(52) U.S. Cl. CPC G02B 6/426; G02B 6/424; G02B 6/4245

(57) ABSTRACT

An SMD optical port is provided that has a leadframe that performs the typical functions of a leadframe and that also performs the mechanical stabilizing functions normally performed by a separate metal backing plate. Therefore, the need for a separate metal backing plate is eliminated, which enables the costs of the SMD optical port to be reduced. The leadframe is configured into two or more leadframe portions that are interconnected. One of the leadframe portions is used as a mounting surface for mounting an optoelectronic package on the leadframe and for making electrical connections. Another of the leadframe portions is configured, or adapted, to attach to a bottom surface of the port housing and to act as a backing plate that mechanically couples the SMD optical port to a mounting surface and mechanically stabilizes the SMD optical port.

### TECHNICAL FIELD OF THE INVENTION

The invention relates to optical communications. More particularly, the invention relates to a surface mount device (SMD) optical port.

### BACKGROUND OF THE INVENTION

In optical communications systems and networks, optical fiber cables are used to interconnect components and to carry optical signals between the components. The optical fiber cables have connectors on each end that terminate the cables. An SMD optical port is an optical port that mounts on a mounting surface, such as a substrate of a printed circuit board (PCB). The SMD optical port is typically attached to the mounting surface during an automated assembly process that uses a pick-and-place machine and a machine vision system to place the SMD optical port and other SMD devices at predetermined locations on the mounting surface.

An SMD optical port has a leadframe that has at least one optoelectronic device (e.g., a laser diode, a light-emitting diode (LED) or a photodiode) attached thereto. The leadframe is typically connected by bond wires to electrical contacts of the optoelectronic device. The SMD optical port typically has a plastic housing with an opening formed therein that is shaped and sized to mate with the connector of the optical fiber cable. The portion of the leadframe to which the optoelectronic device is attached is typically disposed inside of the housing in alignment with the opening of housing to enable optical signals to be coupled between the optoelectronic device and the end of the optical fiber cable. Leads of the leadframe are typically disposed outside of the housing for connection to electrical contacts of the mounting surface. The housing is typically secured to a metal backing plate that is secured to the mounting surface by soldering. The metal backing plate provides mechanical stability to the SMD optical port to prevent it from being dislodged from the mounting surface or moved out of position on the mounting surface.

One disadvantage of these types of SMD optical ports is that the metal backing plate used to provide mechanical stability adds significantly to the cost of the SMD optical port. Another disadvantage of these types of SMD optical ports is that the leads of the leadframe are typically disposed outside of the housing. One of the reasons for disposing the leads outside of the housing is that it allows them to be connected to electrical testing equipment for performing testing. Disposing the leads outside of the housing, however, can result in electromagnetic interference (EMI) problems and can result in other problems due to the exposed leads having electrical current flowing through them.

A need exists for an SMD optical port that obviates the need for the metal backing plate, thereby enabling costs to be reduced. A need also exists for an SMD optical port having a design that allows the leads to be accessed for testing without leaving the leads exposed outside of the port housing.

### SUMMARY OF THE INVENTION

The invention is directed to an SMD optical port. In accordance with an embodiment, the SMD optical port comprises a leadframe, an optoelectronic package, and a port housing. The leadframe has at least first and second leadframe portions. The first leadframe portion has a package-holding area. The second leadframe portion has a mechanical attachment area. The optoelectronic package is secured to the package-holding area and comprises at least one chip that is electrically coupled to one or more leads of the leadframe. The chip is encapsulated in a mold material of the optoelectronic package. The port housing has an optical receptacle formed therein for receiving an end of an optical fiber cable. The first leadframe portion and the optoelectronic package are disposed inside of the port housing and the second leadframe portion is disposed outside of the port housing on a bottom surface of the port housing. When the SMD optical port is mounted on a mounting surface, the mechanical attachment area of the second leadframe portion is bonded to the mounting surface to secure the SMD optical port to the mounting surface and to provide mechanical stability to the SMD optical port.

In accordance with another embodiment, the SMD optical port comprises a leadframe, an optoelectronic package, and a port housing. The optoelectronic package is secured to the leadframe and electrically coupled with one or more leads of the leadframe. The chip of the optoelectronic package is encapsulated in a mold material of the optoelectronic package. The port housing has an optical receptacle formed therein for receiving an end of an optical fiber cable. The optoelectronic package and the portion of the leadframe on which the optoelectronic package is mounted are disposed inside of the port housing. The port housing has a plurality of access openings formed therein in proximity to the leads of the leadframe to allow a test probe to be inserted through the access openings and placed in contact with the respective leads of the leadframe for testing of the optoelectronic package.

These and other features and advantages of the invention will become apparent from the following description, drawings and claims.

### BRIEF DESCRIPTION OF THE DRAWINGS

FIG. 1A illustrates a top perspective view of the SMD optical port in accordance with an illustrative embodiment in disassembled form.

FIG. 1B illustrates a bottom perspective view of the disassembled SMD optical port shown in FIG. 1A.

FIG. 2A illustrates a top perspective view of the SMD optical port shown in FIGS. 1A and 1B in assembled form.

FIG. 2B illustrates a bottom perspective view of the SMD optical port shown in FIGS. 1A and 1B in assembled form.

FIG. 3 illustrates a front plan view of a metal sheet comprising plurality of the leadframes shown in FIGS. 1A and 1B connected together before the leadframes have been separated from one another and folded.

FIG. 4 illustrates an enlarged top perspective view of one of the leadframes shown in FIG. 3 after it has been separated from the other leadframes shown in FIG. 3 and folded into first, second, third, fourth, and fifth leadframe portions.

FIG. 5 illustrates a top perspective view of an SMD optical port in accordance with another illustrative embodiment.

FIG. 6 illustrates a top perspective view of an SMD optical port in accordance with another illustrative embodiment.

FIG. 7A illustrates a top plan view of the SMD optical port shown in FIG. 5.

FIG. 7B illustrates a cross-sectional view of the SMD optical port shown in FIG. 7A taken along line A-A′ of FIG. 7A.

### DETAILED DESCRIPTION OF AN ILLUSTRATIVE EMBODIMENT

In accordance with the invention, an SMD optical port is provided that has a leadframe that performs the typical functions of a leadframe and that also performs the mechanical stabilizing functions normally performed by the aforementioned metal backing plate. Therefore, the need for a separate metal backing plate is eliminated, which enables the costs of the SMD optical port to be reduced. The leadframe is configured into two or more leadframe portions that are interconnected. One of the leadframe portions is used as a mounting surface for mounting an optoelectronic package on the leadframe and for making electrical connections. Another of the leadframe portions is configured, or adapted, to attach to a bottom surface of the port housing and to act as a backing plate that mechanically couples the SMD optical port to a mounting surface and mechanically stabilizes the SMD optical port.

In accordance with an illustrative, or exemplary, embodiment, access openings are formed in the port housing to enable a test probe to be inserted through the access openings and placed in contact with the leads of the leadframe for testing. The only portions of the leads that are outside of the port housing are the portions of the leads that connect to electrical contacts located on the mounting surface. All other portions of the leads are encased inside of the port housing. By encasing those portions of the leads inside of the port housing, potential EMI problems are avoided while still providing access to the leads for testing via the access openings formed in the port housing.

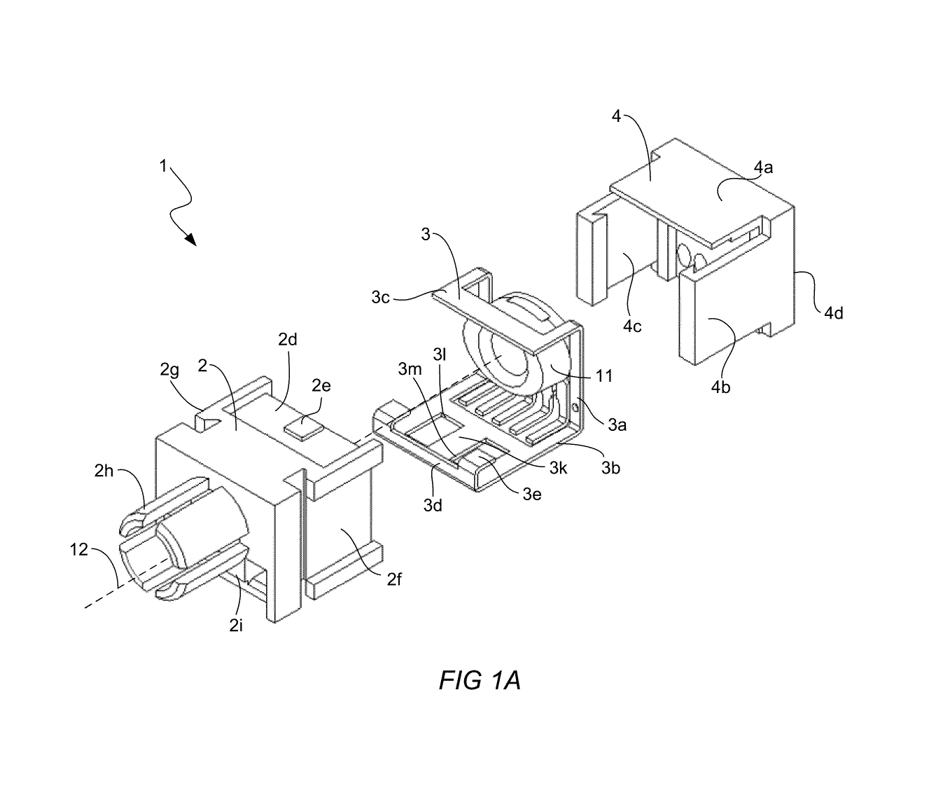

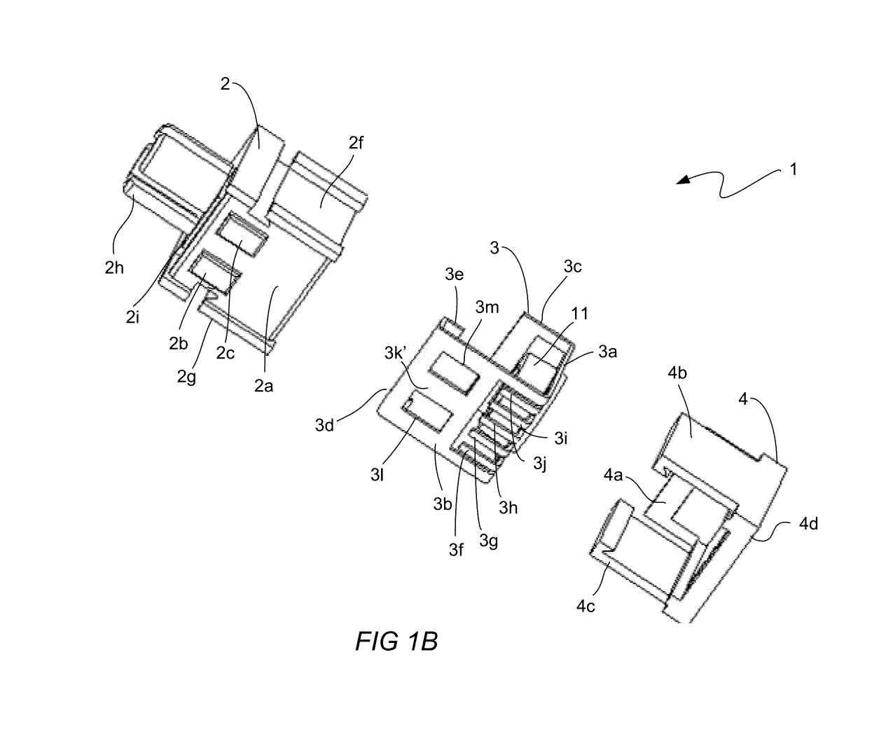

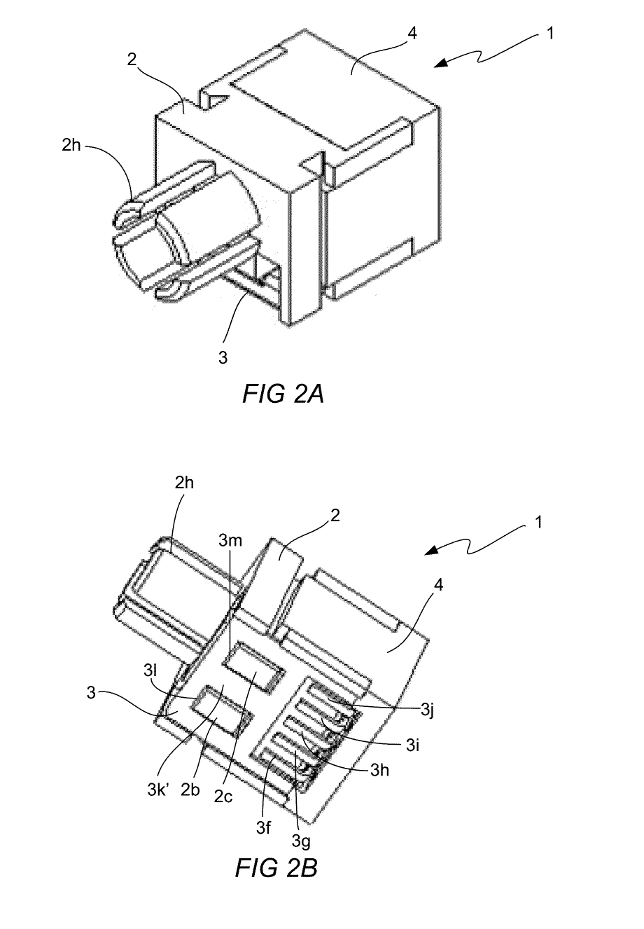

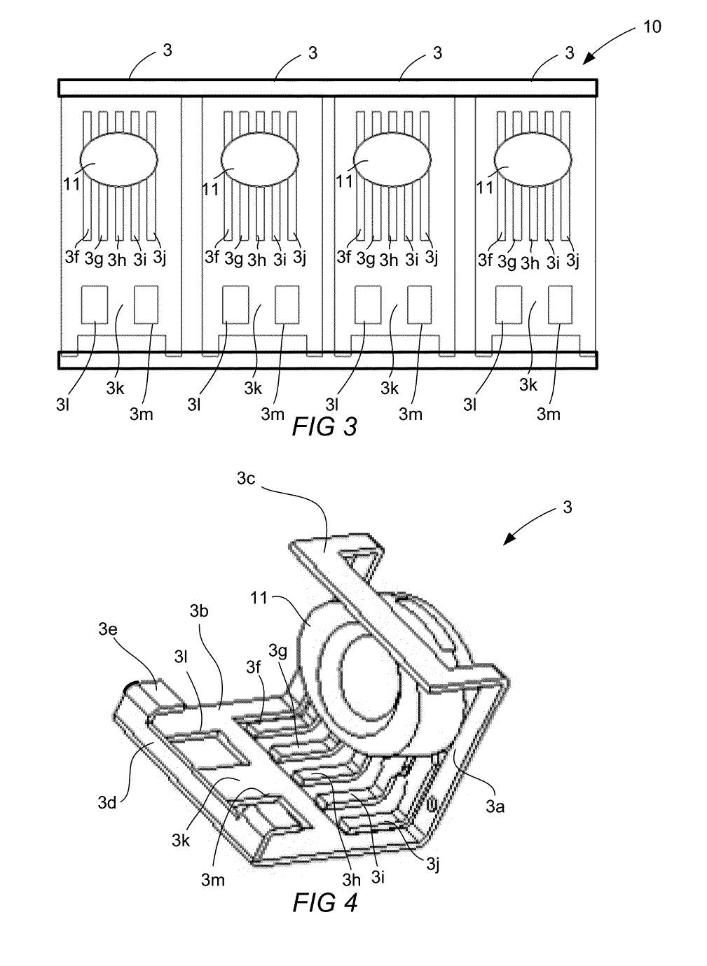

Illustrative, or exemplary, embodiments of the SMD optical port will now be described with reference to the figures, in which like reference numerals represent like features, elements or components. It should be noted that features, elements or components in the figures are not necessarily intended to be drawn to scale. FIG. 1A illustrates a top perspective view of the SMD optical port 1 in disassembled form having a front port housing 2, a leadframe 3 and a back cover 4. FIG. 1B illustrates a bottom perspective view of the disassembled SMD optical port 1 shown in FIG. 1A. FIGS. 2A and 2B illustrate top and bottom perspective views, respectively, of the SMD optical port 1 shown in FIGS. 1A and 1B in assembled form. FIG. 3 illustrates a front plan view of a metal sheet 10 comprising plurality of the leadframes 3 shown in FIGS. 1A and 1B connected together before the leadframes 3 have been separated from one another and folded. FIG. 4 illustrates an enlarged top perspective view of one of the leadframes 3 shown in FIG. 3 after it has been separated from the other leadframes 3 shown in FIG. 3 and folded into first, second, third, fourth, and fifth leadframe portions 3a, 3b, 3c, 3d, and 3e, respectively. An illustrative embodiment of the SMD optical port 1 will now be described with reference to FIGS. 1A-4.

The leadframes 3 are typically mass produced in sheets that are made of a relatively thin metal material, such as, for example, sheet metal. One such sheet 10 is shown in FIG. 3. In accordance with this illustrative embodiment, an optoelectronic package 11 is embedded in each of the leadframes 3. The optoelectronic package 11 includes either a light source (not shown) or a light detector (not shown) and may include additional elements (e.g., passive elements, active elements, driver circuitry, receiver circuitry). The light source is typically either a laser diode or a light-emitting diode (LED). The light detector is typically a photodiode. The light source or light detector is typically embodied in an integrated circuit (IC) die, or chip, having electrically-conductive leads extending therefrom, which are encapsulated in a molded plastic housing of the package 11. Within this molded plastic housing, the contact pads of the chip (not shown) are connected by electrically-conductive bond wires (not shown) to one or more of the leads 3f-3j (FIG. 4) of the leadframe 3. Other electrical components of the package 11 may also be connected by bond wires to one or more of the leads 3f-3j inside of the molded plastic housing of the package 11.

The sheets 10 (FIG. 3) having the optoelectronic packages 11 attached thereto are manufactured using known leadframe manufacturing processes (e.g., stamping, cutting, punching, etc.), which will not be described herein in the interest of brevity. Each sheet 10 is then cut in order to separate the leadframes 3 from one another. Each leadframe 3 is then folded, or bent, into at least first and second leadframe portions 3a and 3b (FIG. 4). The first leadframe portion 3a includes the optoelectronic package 11 and the electrical interconnections (e.g., bond wires) between proximal ends of the leads 3f-3j of the leadframe 3 and the contact pads of the chip (not shown). These electrical connections are inside of the package 11 and therefore are not visible in the figures. The second leadframe portion 3b includes distal ends of the leads 3f-3j (FIG. 4) and a mechanical soldering area 3k. In accordance with the illustrative embodiment, each leadframe 3 is further folded into third, fourth and fifth leadframe portions 3c, 3d and 3e, as shown in FIG. 4. The manner in which leadframes are folded or bent is well known, and therefore will not be described herein in the interest of brevity.

The front port housing 2 (FIG. 1A) and the back cover 4 are typically molded plastic parts that are configured to mate with one another to complete the port housing. The bottom surface 2a (FIG. 1B) of the front port housing 2 has two raised rectangular features 2b and 2c thereon that mate with two windows 3l and 3m (FIG. 1B), respectively, formed in the second leadframe portion 3b when the leadframe 3 and the front port housing 2 are mechanically coupled with one another in the manner shown in FIGS. 2A and 2B. The fourth and fifth leadframe portions 3d and 3e (FIG. 4) together form a curled leadframe portion that wraps around the lower front face 2i (FIGS. 1A and 1B) of the front port housing 2 and extends a short distance inside of the front port housing 2. When the leadframe 3 and the front port housing 2 are coupled together, the third leadframe portion 3c (FIGS. 1A and 4) is positioned on an upper recessed surface 2d (FIG. 1A) of the front port housing 2 and is in contact with a raised rectangular feature 2e located on the upper recessed surface 2d of the front port housing 2. All of these mechanical couplings between the leadframe 3 and the front port housing 2 secure the leadframe 3 to the front port housing 2.

The back cover 4 (FIG. 1A) has a top portion 4a that mates with the upper recessed surface 2d of the front port housing 2. Sides 4b and 4c of the back cover 4 mate with sides 2f and 2g, respectively, of the front port housing 2. A back side 4d of the back cover forms the back of the port housing when the front port housing 2 and the back cover 4 are mated with one another. The sides 4b and 4c of the back cover 4 and the sides 2f and 2g of the front port housing have features formed in or on them that create and interference fit, or snap fit, between the sides 4b and 4c and the sides 2f and 2g, respectively. When the leadframe 3 is secured to the front port housing 2 and the back cover 4 is secured to the front port housing 2, as shown in FIGS. 2A and 2B, the mechanical coupling between the leadframe 3 and the front port housing 2 and between the front port housing 2 and the back cover 4 ensure that there is very little, if any, relative movement among the leadframe 3, the front port housing 2 and the back cover 4.

When the optical port 1 is in its fully-assembled form shown in FIGS. 2A and 2B, the bottom surface 3k′ of the mechanical soldering area 3k of the second leadframe portion 3b is disposed underneath the front port housing 2 (FIG. 2B) to enable it to be soldered to the mounting surface (not shown) on which the SMD optical port 1 will be mounted. The mounting surface is typically, but not necessarily, an upper surface of a printed circuit board (PCB). The lower surfaces of the distal ends of the leads 3f-3j (FIG. 2B) of the leadframe 3 are also disposed underneath the front port housing 2 to enable them to be electrically interconnected to respective electrical contacts disposed on the mounting surface. These electrical interconnections are typically also made by a soldering process. Thus, the process of soldering the bottom surface 3k′ of the mechanical soldering area 3k of the second leadframe portion 3b to the mounting surface can be performed simultaneously with the process of soldering the leads 3f-3j to the respective electrical contacts of the mounting surface.

When the SMD optical port 1 is fully assembled, as shown in FIG. 2a, a round receptacle 2h disposed on the front side of the front port housing 2 is axially aligned with an optical axis of the optoelectronic package 11. In FIG. 1a, the dashed line labeled with reference numeral 12 represents the optical axes of the receptacle 2h and of the optoelectronic package 11. The receptacle 2h is adapted to mate with an end of an optical fiber cable (not shown) or with a connector (not shown) that terminates an end of an optical fiber cable. When an optical fiber cable is connected to the receptacle 2h of the SMD optical port 1, either directly or via a connector, the optical axis of the cable is also aligned with the optical axes of the receptacle 2h and of the optoelectronic package 11.

Thus, in addition to the normal leadframe functions that are performed by the leadframe 3, the lower leadframe portion 3b acts as a backing plate for mechanically coupling the SMD optical port 1 to a mounting surface and for providing the SMD optical port 1 with mechanical stability. By using a portion of the leadframe 3 to perform these additional functions, the need for a separate backing plate is obviated, which enables the overall cost of the SMD optical port 1 to be reduced. In addition, because the process of soldering the bottom surface 3k′ of the mechanical soldering area 3k to the mounting surface can be performed simultaneously with the process of soldering the leads 3f-3j to the respective electrical contacts of the mounting surface, the overall assembly process is simplified, which also reduces costs. It should be noted that although the bottom surface 3k′ of the mechanical soldering area 3k is typically soldered to the mounting surface, other materials could be used to bond the bottom surface 3k′ of the mechanical soldering area 3k to the mounting surface, such as epoxy, for example.

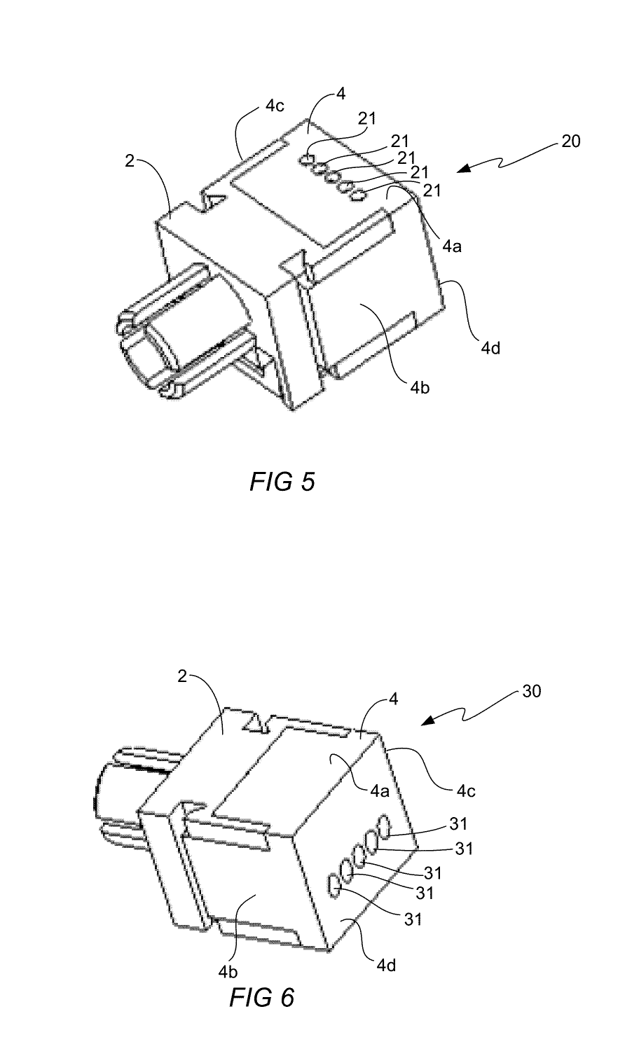

FIG. 5 illustrates a top perspective view of an SMD optical port 20 in accordance with another illustrative embodiment. In accordance with this embodiment, access openings 21 are provided in the top portion 4a of the back cover 4 of the port housing. In all other respects the SMD optical port 20 is identical to the SMD optical port 1 described above with reference to FIGS. 1A-4. The access openings 21 enable a test probe (not shown) to be inserted through the access openings 21 into the port housing and placed in contact with the proximal ends of the leads 3f-3j (FIG. 4) disposed on the first leadframe portion 3a for testing. This feature allows all portions of the leads 3f-3j (FIG. 2B), other than the portions disposed on the bottom of the port housing for connection to the contacts of the mounting surface, to be fully contained within the port housing, which eliminates problems with EMI and other potential problems that may be caused by exposed leads carrying electrical current.

FIG. 6 illustrates a top perspective view of an SMD optical port 30 in accordance with another illustrative embodiment. In accordance with this embodiment, access openings 31 are provided in the back side 4d of the back cover 4 of the port housing. In all other respects the SMD optical port 30 is identical to the SMD optical port 1 described above with reference to FIGS. 1A-4. The access openings 31 enable a test probe (not shown) to be inserted through the access openings 31 into the port housing and placed in contact with the proximal ends of the leads 3f-3j (FIG. 4) disposed on the first leadframe portion 3a for testing. The access openings 31 provide the same advantages as the access openings 21 shown in FIG. 5.

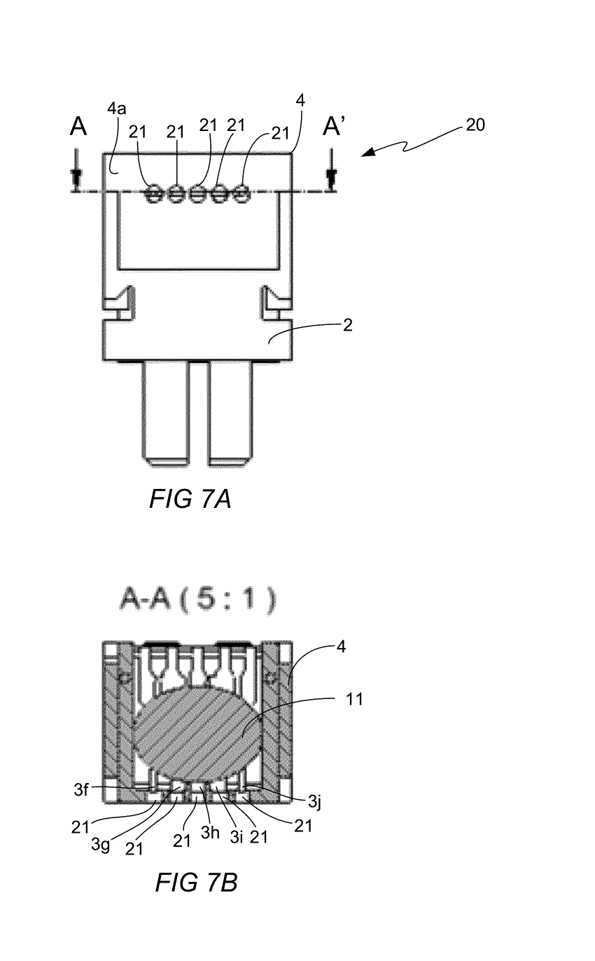

FIG. 7A illustrates a top plan view of the SMD optical port 20 shown in FIG. 5. FIG. 7B illustrates a cross-sectional view of the SMD optical port 20 shown in FIG. 7A taken along line A-A′ of FIG. 7A. In FIG. 7B, the relationship of the access openings 21 to the leads 3f-3j can be seen. Each access opening 21 provides access to one of the leads 3f-3j. Therefore, the leads 3f-3j can be easily placed in contact with a test probe to perform testing of the optoelectronic package 11.

It should be noted that the invention has been described with respect to illustrative embodiments for the purpose of describing the principles and concepts of the invention. The invention is not limited to these embodiments, as will be understood by those of skill in the art in view of the description being provided herein. Many variations may be made to these embodiments within the scope of the invention and all such variations are within the scope of the invention, as will be understood by those skilled in the art in view of the description being provided herein.

What is claimed is:

1. A surface mount device (SMD) optical port comprising:
a leadframe having at least first and second leadframe portions, the first leadframe portion having a package-holding area and the second leadframe portion having a mechanical attachment area;
an optoelectronic package secured to the package-holding area, the optoelectronic package comprising at least one chip that is electrically coupled to one or more leads of the leadframe, wherein the chip is encapsulated in a mold material of the optoelectronic package; and
a port housing having an optical receptacle formed therein for receiving an end of an optical fiber cable, wherein the first leadframe portion and the optoelectronic package are disposed inside of the port housing and wherein the second leadframe portion is disposed outside of the port housing on a bottom surface of the port housing, and wherein when the SMD optical port is mounted on a mounting surface, the mechanical attachment area of the second leadframe portion is bonded to the mounting surface to secure the SMD optical port to the mounting surface and to provide mechanical stability to the SMD optical port.

2. The SMD optical port of claim 1, wherein the port housing comprises a front port housing and a back cover that mate with one another to form the port housing, and wherein inner surfaces of the port housing define an inner region of the port housing, and wherein the first leadframe portion and the optoelectronic package are disposed inside of the inner region, and wherein the second leadframe portion disposed on the bottom surface of the port housing is external to the inner region of the port housing.

3. The SMD optical port of claim 2, wherein proximal ends of leads of the leadframe are part of the first leadframe portion and distal ends of leads of the leadframe are part of the second leadframe portion.

4. The SMD optical port of claim 3, wherein the first leadframe portion is at a non-zero angle to the second leadframe portion.

5. The SMD optical port of claim 4, wherein the non-zero angle is approximately 90°.

6. The SMD optical port of claim 5, wherein the optical receptacle is formed in the front port housing.

7. The SMD optical port of claim 6, wherein the first leadframe portion is in contact with an interior surface of the back cover of the port housing and faces the optical receptacle, and wherein the optical receptacle has an optical axis that is coaxial with an optical axis of the optoelectronic package such that an optical pathway exists between the optical receptacle and the optoelectronic package, and wherein if an optical fiber cable is connected to the optical port, an optical axis of the optical fiber cable is coaxial with the optical axes of the optical receptacle and the optoelectronic package such that an optical pathway exists between the optoelectronic package and the optical fiber cable.

8. The SMD optical port of claim 7, wherein the second leadframe portion is mechanically coupled with at least the bottom surface of the port housing by mechanical coupling features of the bottom surface of the port housing that mate with respective mechanical coupling features of the second leadframe portion.

9. The SMD optical port of claim 7, wherein the mechanical attachment area of the second leadframe portion is bonded to the mounting surface by solder.

10. The SMD optical port of claim 7, wherein the mechanical attachment area of the second leadframe portion is bonded to the mounting surface by an adhesive material.

11. The SMD optical port of claim 7, wherein the chip is an optical-to-electrical (OE) converter chip that converts light that passes through the optical port and is incident on the chip into an electrical signal.

12. The SMD optical port of claim 11, wherein the OE converter chip is a photodiode chip.

13. The SMD optical port of claim 7, wherein the chip is an electrical-to-optical (EO) converter chip that converts an electrical signal into an optical signal, and wherein the optical signal passes out of the SMD optical port through the optical receptacle.

14. The SMD optical port of claim 13, wherein the EO converter chip is a laser diode chip.

15. The SMD optical port of claim 13, wherein the EO converter chip is a light-emitting diode (LED) chip.

16. The SMD optical port of claim 1, wherein the port housing has a plurality of access openings formed therein in proximity to the leads of the leadframe to allow a test probe to be inserted through the access openings and placed in contact with the respective leads of the leadframe for testing of the optoelectronic package.

17. The SMD optical port of claim 16, wherein the access openings are formed in a top side of the port housing.

18. The SMD optical port of claim 16, wherein the access openings are formed in a back side of the port housing.

19. A surface mount device (SMD) optical port comprising:
a leadframe;
an optoelectronic package secured to the leadframe and electrically coupled with one or more leads of the leadframe, wherein the chip is encapsulated in a mold material of the optoelectronic package; and
a port housing having an optical receptacle formed therein for receiving an end of an optical fiber cable, wherein the optoelectronic package and the portion of the leadframe on which the optoelectronic package is mounted are disposed inside of the port housing, the port housing having a plurality of access openings formed therein in proximity to the leads of the leadframe to allow a test probe to be inserted through the access openings and placed in contact with the respective leads of the leadframe for testing of the optoelectronic package.

20. The SMD optical port of claim 19, wherein the access openings are formed in a top side of the port housing.

21. The SMD optical port of claim 19, wherein the access openings are formed in a back side of the port housing.

22. The SMD optical port of claim 19, wherein the leadframe has at least first and second leadframe portions, the first leadframe portion having a package-holding area and the second leadframe portion having a mechanical attachment area, and wherein the optoelectronic package is secured to the package-holding area, and wherein the first leadframe portion and the optoelectronic package are disposed inside of the port housing and wherein the second leadframe portion is disposed outside of the port housing on a bottom surface of the port housing, and wherein when the SMD optical port is mounted on a mounting surface, the mechanical attachment area of the second leadframe portion is bonded to the mounting surface to secure the SMD optical port to the mounting surface and to provide mechanical stability to the SMD optical port.
